(19) United States
(12) Patent Application Publication
(10) Pub. No.: US 2015/0048754 A1
(43) Pub. Date: Feb. 19, 2015

(54) SYSTEMS AND METHODS FOR DATA COMMUNICATION WITH AN LED DEVICE

(71) Applicants: Jeffrey P. Davies, Louisville, CO (US); Steven J. Frank, Framingham, MA (US)

(72) Inventors: Jeffrey P. Davies, Louisville, CO (US); Steven J. Frank, Framingham, MA (US)

(21) Appl. No.: 14/321,281

(22) Filed: Jul. 1, 2014

Related U.S. Application Data
(63) Continuation-in-part of application No. 13/714,795, filed on Dec. 14, 2012.
(60) Provisional application No. 61/576,085, filed on Dec. 15, 2011.

(51) Int. Cl. H05B 33/08

(52) U.S. Cl. CPC H05B 33/08
USPC 315/291

(57) ABSTRACT

Various systems and methods facilitate internal communication within a lighting module as well as communication over an external network. In various embodiments, systems and methods involve direct transmission of operating conditions affecting one or more LEDs to the LED driver via a small electronics package co-located with the LEDs, as well as from the driver and over an external network.

### CROSS-REFERENCE TO RELATED APPLICATION

This is a continuation-in-part of U.S. Ser. No. 13/714,795, filed on Dec. 14, 2012 (the “'795 application”), which claims priority to U.S. Ser. No. 61/576,085, filed on Dec. 15, 2011. The entire disclosures of these priority documents are hereby incorporated by reference.

### TECHNICAL FIELD

Embodiments of the invention generally relate to modular lighting systems capable of communicating over a network.

### BACKGROUND

LEDs represent an attractive alternative to incandescent light bulbs in illumination devices due to their smaller form factor, lower energy consumption, longer operational lifetime, and enhanced mechanical robustness. To provide the aforementioned advantages, LEDs must be controlled and driven properly. In particular, in contrast to incandescent bulbs, the operating conditions (e.g., temperature) to which an LED is subjected used greatly affect the performance (e.g., luminous intensity) thereof. The operating conditions are controlled by an LED driver, typically by regulating the current flowing through the LEDs; the LED driver, however, is typically designed as general-purpose circuitry for use with a wide variety of LEDs. Accordingly, LEDs having different load characteristics may experience substantially varying operating conditions and performance despite using the same driver. In addition, because the input load characteristics of an LED do not remain constant over the LED's lifetime, but instead change with age and environmental conditions, the compatibility between an LED and its driver may erode over time, thereby causing unstable LED performance.

Conventionally, the load characteristics or operating conditions of LEDs are monitored by external circuitry that communicates the monitored information over an external data path to the LED driver. Upon detecting changes in the load characteristics or operating conditions of LEDs, for example, the external circuitry transmits a feedback signal to the LED driver to change the output load impedance or signal frequency to compensate for the changes. The external circuitry may involve, for example, a temperature-sensitive element (e.g., thermistor, thermocouple, etc.) positioned near the LEDs and a discrete data channel to communicate the sensed temperature. Such complex and specialized circuit designs can be expensive and inconveniently implemented, especially when the sensing system is far from the driver. Additionally, various schemes for communicating the LED performance information may interrupt normal operation of the LEDs.

Consequently, there is a need for circuitry that can reliably monitor the operating conditions of the LEDs without interrupting normal operation, vary the output of the LED driver to optimize the performance of the LEDs, and is conveniently deployed in a luminaire or other LED-based device. At the same time, if the problem cannot be corrected locally, the ability to communicate the problem externally can be valuable as well. Indeed, even for locally correctable problems, external communication capability can facilitate aggregation of anomaly data throughout a lighting deployment to identify recurring problems that may eventually compromise local or more widespread system performance, or whose existence can suggest the need for system adjustment or reconfiguration.

### SUMMARY

In various embodiments, the present invention relates to systems and methods for directly transmitting operating conditions affecting one or more LEDs to the LED driver via a small electronics package co-located with the LEDs, as well as from the driver and over an external network. The electronics package may include a microcontroller to activate a component (e.g., a thermistor) that monitors one or more operating conditions (for example, the temperature) of the LEDs and then transmits the measured information to the electronics of the LED driver, preferably by modulating the driver load with circuitry (e.g., a transistor and a resistor) in a manner that conveys the information. The electronics package (or at least the sensing component thereof) is compact and located sufficiently proximate to the LED(s) to detect relevant operating conditions without interrupting normal LED operation.

Use of a simple and small electronics package allows the LED driver to selectively and directly monitor LED operating conditions and adjust the operating current/voltage to optimize LED performance and lifetime. The direct transmission of the information-containing signals by load modulation obviates the need for a dedicated communication channel between the LED(s) and the LED driver, and thus avoids using unnecessary internal circuitry to convey information; this simplifies the overall circuit design. Furthermore, communication by load modulation alters the LED load at a level sufficient for data detection by the LED driver but insufficient to be detected by the human eye, thereby imposing at most a negligible impact on normal LED operation.

A communication interface facilitates communication over a network. As used herein, the term “network” broadly connotes any arrangement facilitating communication between nodes connected or connectable over the network. An “internal” network facilitates communication within a lighting module between a controller and one or more light sources (e.g., light-emitting diodes, or LEDs) of the lighting module. An “external” network permits wired or wireless networks among modules and between a module and an external device such as a computer, smart phone, tablet or other device capable of communication over the network. An external network may be maintained by an organization and/or may utilize the public telecommunications infrastructure. External networks include local area networks (LANs), wide area networks (WANs) and/or other types of networks. When used in a LAN networking environment, computers may be connected to the LAN through a network interface or adapter. When used in a WAN networking environment, nodes typically include a modem or other communication mechanism. Modems may be internal or external, and may be connected to the system bus via the user-input interface, or other appropriate mechanism. Nodes may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Wireless communications may also involve visible or non-visible (e.g., infrared) light. Furthermore, components of the system may communicate through a combination of wired or wireless paths.

Accordingly, in one aspect, the invention pertains to a system for communicating one or more operating conditions of an LED device. In various embodiments, the system comprises an LED driver; sensing circuitry for sensing an operating condition affecting the LED device; a communication interface; and a controller, responsive to the sensing circuitry, for (i) internally communicating the sensed condition to the LED driver by modulating a load of the LED driver based on the sensed operating condition, and (ii) selectively communicating the sensed condition over an external network via the communication interface. For example, the sensed operating condition may correspond to an anomaly, with the controller being configured to communicate the sensed operating condition over the external network when adjusting operation of the driver does not correct the anomaly.

The sensed operating condition may communicated over the external network via the communication interface when a value of the operating condition exceeds a stored threshold value and/or when a stored rule is satisfied.

In some embodiments, the system further comprises a device, responsive to the controller, for switching a load in and out of the LED driver load. The controller may be configured to modulate the load in a temporal pattern corresponding to a digital value that itself corresponds to the sensed operating condition. For example, the temporal pattern may correspond to a bit rate faster than the activation rate of the sensing circuitry. The controller may generate a data packet for internal and external communication based on the operating condition.

In another aspect, the invention pertains to a method of controlling an LED device connected to an LED driver. In various embodiments, the method comprises the steps of sensing an operating condition affecting the LED device; internally communicating the sensed condition to the LED driver by modulating a load of the LED driver based on the sensed operating condition; and selectively communicating the sensed condition over an external network.

In some embodiments, the further comprises the step of varying the output of the LED driver based on the modulated load. The sensed operating condition corresponds to an anomaly and is transmitted over the external network when varying the LED driver output fails to correct the anomaly. Alternatively or in addition, the sensed operating condition may be communicated over the external network via the communication interface when a value of the operating condition exceeds a stored threshold value and/or when a stored rule is satisfied.

In some embodiments, the method further comprises the step of switching a load in and out of the LED driver load. The load may be modulated in a temporal pattern corresponding to a digital value that itself corresponds to the sensed operating condition. The temporal pattern, in turn, may correspond to a bit rate faster than the activation rate of circuitry for sensing the operating condition. In some embodiments, the method further comprises the step of generating a data packet for internal and external communication based on the operating condition.

On the driver side, in representative embodiments, the system includes sensing circuitry for sensing an operating condition affecting the LED device and communication circuitry for modulating a load of the LED driver based on the sensed operating condition, thereby communicating the sensed condition to the LED driver. The sensing circuitry may include a thermistor. In various embodiments, the communication circuitry includes a device for switching a load in and out of the LED driver load. The device may include a transistor and the load may include a resistor. In one implementation, the communication circuitry includes a controller for controlling the device based on data from the sensing circuitry.

As used herein, the term “approximately” means±10°, and in some embodiments, ±5°. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 schematically depicts circuitry of an LED lighting system in accordance with an embodiment of the present invention.

FIG. 2A is a schematic of a small electronics package in accordance with an embodiment of the invention.

FIGS. 2B-2D depict schematics of various circuitry employed in the small electronics package in accordance with an embodiment of the invention.

FIG. 3 is a schematic of an LED lighting system employing a small electronics package to monitor operating conditions of multiple LED units in accordance with an embodiment of the invention.

FIG. 4 schematically depicts a plurality of lighting systems, each of which include an internal network as illustrated in FIG. 3, connected to an external network.

### DETAILED DESCRIPTION

Embodiments of the present invention involve lighting modules capable of internal communication between a controller and one or more light sources over an internal network, and external communication over an external network. Described below are, first, an embodiment of a lighting module configured for internal communication by modulating a driver load with circuitry (e.g., a transistor and a resistor) in a manner that conveys the information to a microcontroller, and then how such lighting modules may be enhanced to communicate over an external network.

### 1. Lighting Modules and Internal Communication

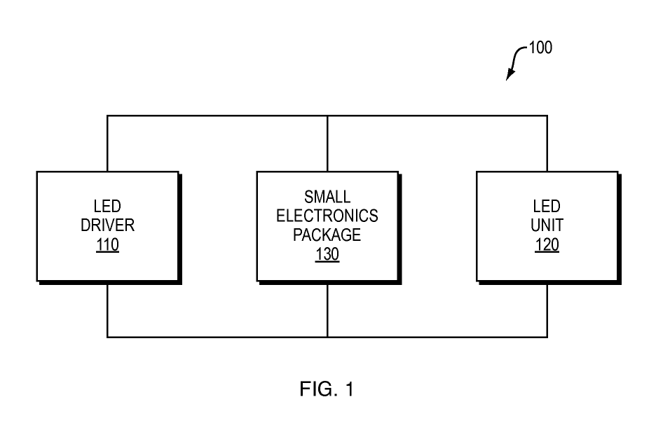

FIG. 1 illustrates an LED lighting system 100 that includes an LED driver 110 applying power to an LED unit 120 and a small electronics package 130 for communicating one or more relevant operating conditions (e.g., temperature) of the LED unit 120 to the LED driver 110. The LED unit 120 may include one or multiple LEDs electronically connected in parallel or in series and/or LED support circuitry. The LEDs may be, for example, solid-state LEDs, organic LEDs, polymer LEDs, phosphor coated LEDs, high-flux LEDs, or micro-LEDs. Each LED may be supplied with current by an independent LED driver 110, or a group of LEDs may share one LED driver 110. The LED driver 110 may be a constant-voltage source or a constant-current source, depending on the implementation, and includes at least one electronic component (e.g., an active device or a passive device) for providing a steady voltage or current to the LED unit 120. For example, a constant-voltage source may be DC batteries, which are capable of providing a sufficiently high DC voltage to turn on the LEDs, and a constant-current source may utilize a transistor or a resistor to provide a controlled current through the LED unit 120. In response to LED operating conditions, as measured and transmitted by the electronics package 130, the LED driver 110 may adjust the voltage or current supplied to the LED unit 120.

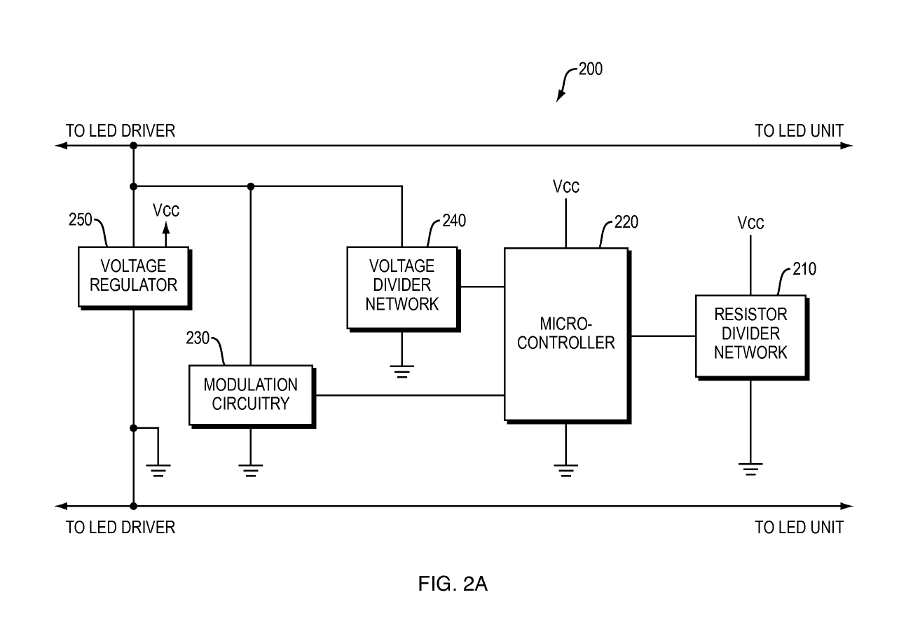

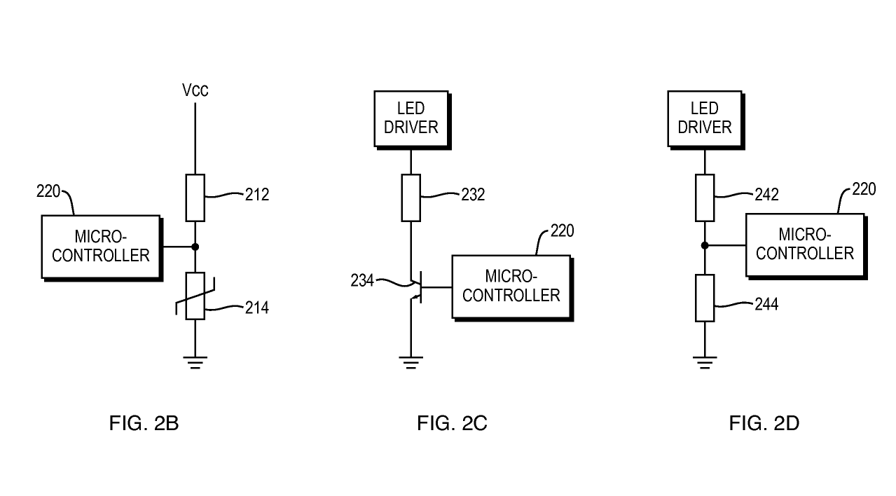

In various embodiments, the electronics package 130 is a single, compact unit that can be easily installed in and removed from the LED lighting system 100. With reference to FIG. 2A, in one embodiment, the small electronics package 200 includes a resistor divider network 210 to monitor one or more operating conditions (for example, the temperature) of the LED unit 120. As depicted in FIG. 2B, the resistor divider network 210 may include or consist of, for example, a resistor 212 and a thermistor 214 or other device which can be used to measure the temperature or other operating condition(s) of the LED unit 120. Because the resistance of the thermistor 214 varies with the LED temperature and can be defined as ΔR=kΔT, where AR and ΔT are changes in resistance and temperature, respectively, and k is the first-order temperature coefficient of resistance, the LED temperature can be monitored by constantly measuring the resistance of the thermistor 214. In one embodiment, a microcontroller 220 monitors the voltage developed across the thermistor 214, thereby determining the thermistor resistance.

Upon detecting the resistance of the thermistor 214, the microcontroller 220 computes the corresponding LED temperature and converts the detected temperature information into a signal that can be transmitted to the LED driver 110. For example, the measured temperature may first be converted to an 8-bit digital value. The microcontroller 220 then transmits this digital signal to the LED driver circuitry 110 by modulating the driver load with modulation circuitry 230. That is, the modulation circuitry 230 alters the driver load in a temporal pattern indicative of the digital value. This signal is sensed as a loading variation by the driver circuit 110 (see FIG. 1) and interpreted to recover the digital value. Based on this recovered value, the driver 110 alters the current and/or voltage supplied to the LED unit 120.

As a result, changes in the driver load communicated by the modulation circuitry 230 result in alteration of the operating current/voltage supplied to the LED unit in order to optimize the performance and lifetime of the LEDs. The modulation circuitry 230 may include, for example, a resistor 232 and a transistor 234 (or other switch), as depicted in FIG. 2C. The transistor 234 is turned on and off based on the digital temperature signal; this switches the resistor 232 in and out of the driver load circuitry and thus modulates the driver load on a bit-by-bit basis. Upon switching in the resistor 232 of the modulation circuitry 230, the resistance relative to the LED driver decreases, thus allowing the driving current to increase and creating a coincident drop in voltage at the LED unit 120. When the transistor 234 of the modulation circuitry 230 is turned off by the microcontroller 220, the driving current decreases due to the increased resistance, and the voltage across the LED unit returns to its normal operating value. Usually, a change of a few percent in the drive voltage can be detected by the driver electronics. Furthermore, the small change in the LED load due to the load modulation is preferably undetectable to the human eye, and thus typically represents a negligible effect on normal LED operation. For example, in one implementation, an average current of 120 mA flowing through the LED unit 120 fluctuates between 15 mA and 200 mA, corresponding to a voltage fluctuation between 42 V and 54 V during normal operation. Upon turning on the transistor 234 of the modulation circuitry 230, the current flowing through the transistor 234 increases to approximately 200 mA, corresponding approximately to a change of 1 V across the LED unit, for a duration of approximately 80 μs. This voltage change, i.e., 1 V, may be easily detected by the driver circuitry, but is undetectable by the human eye since it is only 2% of the normal LED operating voltage and is so brief (i.e., 80 μs).

In one embodiment, the microcontroller 220 monitors the output current waveform of the LED driver 110 using a voltage-divider network 240 and then synchronizes the data bit rate accordingly. For example, for a regular rectified output current waveform having a frequency of 120 Hz, the microcontroller 220 may transmit the measured temperature data with a bit rate of 120 Hz, thereby modulating the driver output waveform synchronously with each period (e.g., at the peak voltage). If the temperature data is represented by 8 bits, the data-transmission time is approximately 65 ms; the electronics package 220 thus ensures quick feedback to adjust the operating current/voltage of the LEDs in real time in response to changes in the operating conditions thereof. As shown in FIG. 2D, a suitable voltage divider network 240 can include or consist of a simple pair of resistors 242, 244. The voltage between these resistors 242, 244 can be monitored by the microcontroller 220 to facilitate transmitting temperature data bits synchronized to the periodic waveform of the LED current and voltage. Alternatively, the data bits may be sent asynchronously. Although the discussion herein focuses on an operating condition having an 8-bit digital signal for purposes of illustration, the present invention is not limited to any particular number of signal bits.

Furthermore, operating conditions other than temperature may be monitored. For example, the modulation circuitry 230 may be electrically responsive to another environmental condition (such as humidity or the degree of incident solar radiation) or an operating parameter of the LED(s), e.g., variations in the forward voltage, output wattage, lifetime operating hours, LED color temperature, or room occupancy detection. These conditions are measured and signals indicative of the measurements are communicated to the driver circuitry via modulation as described above.

In various embodiments, a voltage regulator 250 provides suitable power to the microcontroller 220. When the operating conditions of the LED unit 120 are not monitored or transmitting data to the LED driver 110 is not necessary, the microcontroller 220 may be deactivated to minimize power consumption.

The microcontroller 220 may be provided as either software, hardware, or some combination thereof. Similarly, the driver circuitry contains circuitry to sense the loading modulations imparted by the modulation circuitry and suitable internal logic to decode the communication and take appropriate action, e.g., varying the supplied voltage and/or current. These functions may be implemented by computational circuitry including a main memory unit for storing programs and/or data relating to the activation or deactivation described above. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), or programmable logic devices (PLD). For embodiments in which the controller is provided as a software program, the program may be written in low-level microcode or in a high-level language such as FORTRAN, PASCAL, JAVA, C, C++, C#, LISP, PERL, BASIC, PYTHON or any suitable programming language.

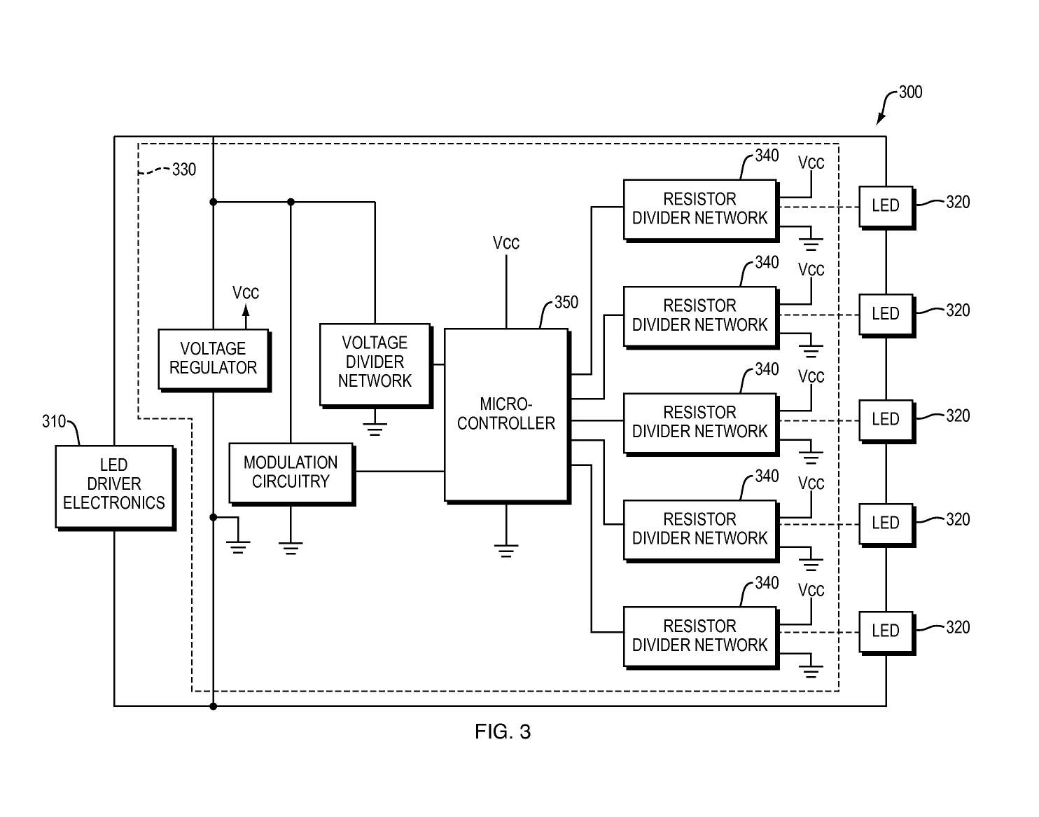

With reference to FIG. 3, in some embodiments, an LED lighting system 300 includes an LED driver 310 applying power to multiple LED units 320 and a small electronics package 330, which senses and measures at least one operating condition affecting each LED unit 320. The electronics package 330 may include multiple resistor divider networks 340, each monitoring an operating condition of one of the LED units 320. The monitored operating condition of each LED unit 320 may be the same or different. Upon receiving various operating conditions of the LED units 320, a microcontroller 350 in the electronics package 330 modulates the driver load, using the approach as described above, in order to communicate the sensed operating condition to the driver circuitry 310; the driver 310, in turn, modifies the drive signal applied to the LED units 320 in order to optimize their overall performance and lifetime.

In one embodiment, the microcontroller 350 transmits the operating-condition information of the LED units 320 at a low periodic rate (e.g., 0.1 Hz). Because the data transmission time from each LED unit 320 to the LED driver 310 is relatively short (e.g., 65 ms), the transmission of each LED unit 320 takes only approximately 0.6% of the time between transmissions. Accordingly, the likelihood of data interference between the multiple transmission lines of the LED units 320 is very low, thereby effectively avoiding data collisions in the LED driver electronics 310. In addition, when multiple devices are incorporated in the LED lighting system 300 and transmit various signals on the same drive channel, the low data update rate (e.g., every 10 seconds) advantageously minimizes a probability of data collisions in the driver electronics from the multiple devices.

In some embodiments, the measured information about the operating conditions (e.g., temperature) is converted to a data packet including a header sequence to establish the start of the data, a payload containing the digitized temperature data, and a trailer sequence to mark the end of the packet. The header sequence includes instructions about the temperature data carried by the packet; for example, the header sequence may include a board number or other identifiers to set up a data rate and/or a data size (e.g., 8-bit temperature value) and/or the synchronization of the bit rate with the frequency of the driver waveform. Additionally, the data packet may include a code (such as a checksum or cyclic redundancy check (CRC) value) in the trailer sequence to detect errors that are introduced into the data packet during transmission. For example, the microcontroller may detect bits having a value of “1” in the payload, sum up the total value thereof, and store the summation as a hexadecimal value in the trailer sequence. Upon receiving the data packet via modulation as described above, the LED driver electronics sums up the bits having a value of “1” in the payload and compares the results with the value stored in the trailer sequence. If the values match, it indicates that the temperature data in the payload is correct. If the values do not match, the receiving LED driver electronics ignores the corrupted data and waits for the next transmission cycle. Accordingly, the checksum or CRC value may reliably and effectively facilitate the identification of corrupted data or data with low signal-to-noise ratio (SNR) values.

### 2. External Communication

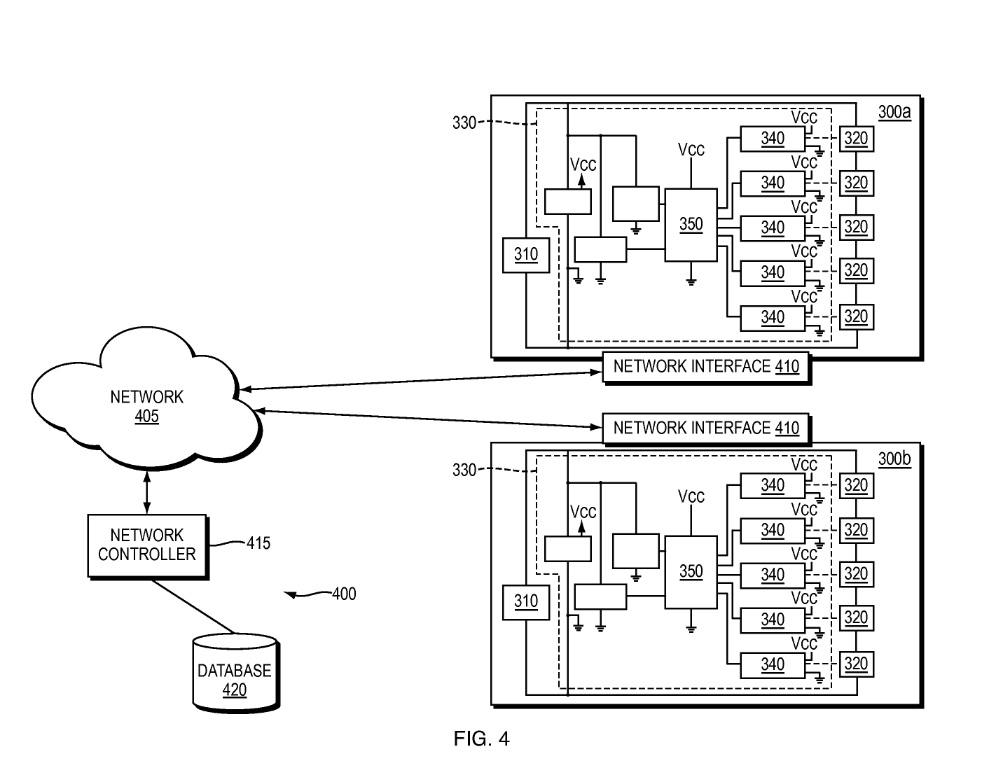

FIG. 4 illustrates a representative system 400 including an external network 405 over which a series of lighting modules as described above, representatively indicated at 300a, 300b, communicate. Each of the lighting modules 300 includes a network interface 410. This is a conventional component facilitating communication over the network 405. In some embodiments, the network interface 410 includes a webserver block facilitating communication with the associated module via HTTP.

As noted previously, the external network 405 may be wired and/or wireless, and may be an enterprise network, the Internet, an intranet, the public telecommunications infrastructure, etc. In one particular embodiment, the external network 405 utilizes, as the network medium, power lines that run through a home or building, and communication thereover occurs via “power line networking” using interface adapters well known in the art. Thus, each lighting module can be connected to the power lines (e.g., plugged into a wall outlet, wired in via a junction box, etc.) both to obtain power and for communication. Internally, the module controllers and light sources may interrupt the power signal as described above in order to communicate; so long as these interruptions occur only for a small portion of the duty cycle of the power signal, the power line network will be able to tolerate it (with error correction, if necessary).

A network controller or network-connected interface device 415, of which there may be more than one, facilitates communication with one or more of the lighting modules 300, obtaining data therefrom and/or sending commands thereto. An interface device may be a computer, tablet, telecommunication device, etc. For example, an interface device may run a web browser and communicate, via the Internet, with lighting modules 300 via a webserver embedded in the network interface 410 of the selected device; in such configurations, each device 300 has a different Internet (IP) address. As explained in greater detail below, a network controller or interface device 415 may include a database 420.

As illustrated in FIG. 4, the lighting modules 300a, 300b include the components described above in connection with lighting modules 300 as well as a network interface 410. Also as noted above, the microcontroller 350 of each lighting module 300 includes volatile and nonvolatile memory storage and suitable programming. Such programming may further implement functions associated with external communication over the network 405 as described below.

In various embodiments, the memory of the microcontroller 350 stores conditions or rules which, when satisfied, result in external communication of a sensed condition via the network interface 410. For example, the microcontroller 350 may be programmed to selectively transmit, to the external device 415 via the network 405, a sensed temperature of one or more of the LEDs 320 when a stored rule is satisfied—for example, (i) the temperature of a single LED 300 exceeds an absolute anomaly threshold, (ii) the temperatures of a plurality of LEDs 300 exceed an anomaly threshold, (iii) the temperature of one or more LEDs 300 has exceeded a lower anomaly threshold for more than a certain period of time, or (iv) a temperature above an anomaly threshold has been detected in one or more LEDs 300 more than a certain number of times within a specified period of time. Furthermore, as noted above, sensors associated with the lighting modules 300 may detect conditions such as humidity, incident solar radiation, room occupancy, or operating parameters such as variations in the forward voltage, output wattage, lifetime operating hours, or LED color temperature. The microcontroller 350 may store a table or database of associated rules and actions for each type of sensor, so that if more than one type of sensor is deployed in connection with a particular lighting module 300, the microcontroller programming consults the table in response to sensor readings to determine whether a trigger condition is satisfied and, if so, to take the specified action—e.g., to communicate externally, to store the sensed value in a database, or to take no action beyond internal communication. Thus, entry of a person into the area monitored by an occupancy sensor may trigger an external communication after, but not during, business hours. A global rule may trigger external communication when internal communication fails to ameliorate an anomalous condition.

Some sensor readings, such as LED operating parameters, may be transmitted automatically on a periodic basis. Such readings may be stored by the network controller (and/or other network-connected interface) in the database 420 for subsequent analysis. The rule base and action triggers may be reconfigurable, e.g., via communication with a microcontroller 350 using the network interface 410.

As further noted above, internal communication within a lighting module 300 may occur by way of data packets—i.e., the microcontroller 350 may convert signals received from a sensor into a data packet communicated to the LED driver 310 via modulation circuitry. If the selected data packet format is suitable for transmission over the network 405 (e.g., if it is formatted as an IP packet), it may additionally be transmitted thereover via the communication interface 410 when the stored external transmission rules so dictate.

Conversely, the network controller 415 may periodically, or in response to an event, query one or more lighting modules 300 to obtain data therefrom. This is especially convenient if the network interface 410 includes a webserver and the microcontroller 350 creates IP packets at least for external communication. The network controller 415 may query a lighting module at whatever level of granularity is appropriate to the circumstances, e.g., across LEDs or even for data relating to a particular, specified LED of the module. Similarly, the network controller 415 may aggregate data in the database 420, for example, across the LEDs in a single lighting module 300 or, more broadly, across lighting modules in a room, building, campus or within any defined set.

Finally, the network controller 415 may reprogram a microcontroller 350 by commands sent through the network interface 410; the microcontroller or network interface may implement an authentication protocol so that only authorized users can affect the operation of the microcontroller. Reprogramming may involve revising or substitute functional code of the microcontroller, or changing triggering conditions by, for example, altering values in the rules table or database.

Any suitable programming language may be used to implement without undue experimentation the communication functions and rule and data processing functions discussed above. As noted previously, programming may be written in low-level microcode or in a high-level language such as FORTRAN, PASCAL, JAVA, C, C++, C#, LISP, PERL, BASIC, PYTHON or any suitable programming language. Further, it is not necessary that a single type of instruction or programming language be utilized in conjunction with the operation of the system and method of the invention. Rather, any number of different programming languages may be utilized as is necessary or desirable. It should be noted that embodiments of the present invention (or programmed portions thereof) may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for communicating one or more operating conditions of an LED device, the system comprising:
an LED driver;
sensing circuitry for sensing an operating condition affecting the LED device;
a communication interface; and
a controller, responsive to the sensing circuitry, for (i) internally communicating the sensed condition to the LED driver by modulating a load of the LED driver based on the sensed operating condition, and (ii) selectively communicating the sensed condition over an external network via the communication interface.

2. The system of claim 1, wherein the sensed operating condition corresponds to an anomaly and the controller is configured to communicate the sensed operating condition over the external network when adjusting operation of the driver does not correct the anomaly.

3. The system of claim 1, wherein the sensed operating condition is communicated over the external network via the communication interface when a value of the operating condition exceeds a stored threshold value.

4. The system of claim 1, wherein the sensed operating condition is communicated over the external network via the communication interface when a stored rule is satisfied.

5. The system of claim 1, further comprising a device, responsive to the controller, for switching a load in and out of the LED driver load.

6. The system of claim 1, wherein the controller is configured to modulate the load in a temporal pattern corresponding to a digital value that itself corresponds to the sensed operating condition.

7. The system of claim 6, wherein the temporal pattern corresponds to a bit rate, the bit rate being faster than an activation rate of the sensing circuitry.

8. The system of claim 6, wherein the controller generates a data packet for internal and external communication based on the operating condition.

9. A method of controlling an LED device connected to an LED driver, the method comprising the steps of:
sensing an operating condition affecting the LED device;
internally communicating the sensed condition to the LED driver by modulating a load of the LED driver based on the sensed operating condition; and
selectively communicating the sensed condition over an external network.

10. The method of claim 9, further comprising the step of varying an output of the LED driver based on the modulated load.

11. The method of claim 10, wherein (i) the sensed operating condition corresponds to an anomaly and (ii) the sensed operating condition is transmitted over the external network when varying the LED driver output fails to correct the anomaly.

12. The method of claim 9, wherein the sensed operating condition is communicated over the external network via the communication interface when a value of the operating condition exceeds a stored threshold value.

13. The method of claim 9, wherein the sensed operating condition is communicated over the external network via the communication interface when a stored rule is satisfied.

14. The method of claim 9, further comprising the step of switching a load in and out of the LED driver load.

15. The method of claim 9, wherein the load is modulated in a temporal pattern corresponding to a digital value that itself corresponds to the sensed operating condition.

16. The method of claim 15, wherein the temporal pattern corresponds to a bit rate, the bit rate being faster than an activation rate of circuitry for sensing the operating condition.

17. The method of claim 9, further comprising the step of generating a data packet for internal and external communication based on the operating condition.
